(19) United States
(12) Patent Application Publication
(10) Pub. No.: US 2024/0292039 A1
(43) Pub. Date: Aug. 29, 2024

(54) METHOD OF SWITCHING AUDIO INPUT AND OUTPUT APPLIED TO LIVE STREAMING, AND LIVE STREAMING DEVICE

(71) Applicant: BEIJING BYTEDANCE NETWORK TECHNOLOGY CO., LTD., Beijing (CN)

(72) Inventor: Yingyi CHEN, Beijing (CN)

(21) Appl. No.: 18/573,325

(22) PCT Filed: May 23, 2022
(86) PCT No.: PCT/CN2022/094396

§ 371 Date: Dec. 21, 2023

(30) Foreign Application Priority Data
Jul. 13, 2021 (CN) 202110791411.7

(51) Int. Cl. H04N 21/233; G06V 10/44; H04N 21/2187

(52) U.S. Cl. CPC H04N 21/233; G06V 10/443; H04N 21/2187

(57) ABSTRACT

Embodiments of the present provide a method of switching audio input and output applied to live streaming and a live streaming device, including: obtaining a live stream image of an live streamer during live streaming, and determining a live scene of the live streamer according to the live stream image, the live scene including a far-field scene and a near-field scene; in response to a change of the live scene, switching audio input and output of a live streaming device according to the change of the live scene.

This application claims the priority of the Chinese patent application entitled “a method for switching audio input and output applied to live streaming, and a live streaming device” with the application number of 202110791411.7 and the filing date of Jul. 13, 2021, the content of which is hereby incorporated in its entirety by reference.

### FIELD

Embodiments of the present disclosure relate to the technical field of computer and network communication and in particular to, a method of switching audio input and output applied to live streaming, live streaming device, electronic device, readable storage medium, computer program product and computer program.

### BACKGROUND

With the development of the Internet, live streaming has become a new trend of art performance, in which the performer of live streaming is called a live streamer, and the device for live streaming is called a live streaming device. The live streamer may communicate with the audience through the live streaming device.

During live streaming, audio input and output need to be switched between far-field and near-field scenes. For example, in the far-field scene, the audio output needs to support external speakers, so that both the live streamer and the audience can hear it. In the near-field scene, external speakers need to stop. In the prior art, audio input and output need to be switched manually by the live streamer.

However, due to the low timeliness and reliability, manual switching is particularly cumbersome especially when live streamers frequently switch between the far field and the near field.

### SUMMARY

Embodiments of the present disclosure provide a method of switching audio input and output applied to live streaming, a live streaming device, an electronic device, a readable storage medium, a computer program product and a computer program, in order to overcome the cumbersome operation of manual switching and avoid the problem of low timeliness and reliability of manual switching.

In a first aspect, the embodiments of the present disclosure provide a method of switching audio input and output applied to live streaming, comprising:
obtaining a live stream image of a live streamer during live streaming, and determining a live scene of the live streamer according to the live stream image, the live scene including a far-field scene and a near-field scene.
in response to a change of the live scene, switching audio input and output of a live streaming device according to the change of the live scene.

In a second aspect, the embodiments of the present disclosure provide a live streaming device, comprising:
a main control component, used to obtain a live stream image of a live streamer during live streaming, and determining a live scene of the live streamer according to the live stream image, the live scene including a far-field scene and a near-field scene;
wherein the main control component is further used to generate switching instructions in response to a change of the live scene and transmit the switching instructions to an audio processor, wherein the switching instructions are used to instruct the audio input and output of the live streaming device to be switched;
the audio processor is used to switch the audio input and output of the live streaming device according to the switching instructions.

In a third aspect, the embodiments of the present disclosure provide an electronic device, comprising: at least one processor and a memory;
the memory storing computer executable instructions;
the at least one processor executing computer executable instructions stored in the memory to cause the at least one processor to perform the method according to the first aspect and various possible methods according to the first aspect.

In a fourth aspect, the embodiments of the present disclosure provide a computer readable storage medium having computer executable instructions stored thereon, the computer executable instructions, when executed by a processor, implementing the method according to the first aspect and various possible methods according to the first aspect.

In a fifth aspect, the embodiments of the present disclosure provide a computer program product which, when executed by a processor, implementing the method according to the first aspect and various possible methods according to the first aspect.

In a sixth aspect, the embodiments of the present disclosure provide an apparatus for switching audio input and output applied to live streaming, comprising:
an obtaining unit, used to obtain a live stream image of a live streamer during live streaming;
a determining unit, used to determine a live scene of the live streamer according to the live stream image, the live scene comprising a far-field scene and a near-field scene;
a switching unit, used to switch, in response to a change of the live scene, audio input and output of a live streaming device according to the change of the live scene.

In a seventh aspect, according to one or more embodiments of the present disclosure, a computer program is provided which, when executed by a processor, implements the method according to the first aspect and various possible methods according to the first aspect.

The switching method for audio input and output applied to live streaming and the live streaming device provided by the embodiments comprise: obtaining a live stream image of a live streamer during live streaming, and determining a live scene of the live streamer according to the live stream image, the live scene including a far-field scene and a near-field scene; in response to a change of the live scene, switching audio input and output of a live streaming device according to the change of the live scene. In the embodiments, the following technical features are introduced: determining the live scene based on the live stream image, and when the live scene changes, switching audio input and output based on the change of the live scene. This avoids the drawbacks of complicated operation caused by the live streamer manually switching the audio input and output of the live streaming device when the live scene changes, improves the automation of the live streaming, satisfies the live streaming experience of the live streamer, makes the live streaming smoother as a whole, improves the reliability of the live streaming and further satisfies the viewing experience of the audience.

### BRIEF DESCRIPTION OF THE DRAWINGS

In order to more clearly illustrate the technical solution in the embodiments of the present disclosure or the prior art, a brief introduction is presented below to the drawings required to be used in the description of the embodiments or the prior art. It is obvious that the drawings in the description below are some embodiments of the present disclosure. For those of ordinary skill in the art, they may obtain other drawings from these drawings without the exercise of any creative skill.

FIG. 1 is a schematic diagram of a scenario of a switching method for audio input and output applied to live streaming according to the embodiments of the present disclosure;

FIG. 2 is a schematic diagram of a switching method for audio input and output applied to live streaming according to an embodiment of the present disclosure;

FIG. 3 is a schematic diagram of a switching method for audio input and output applied to live streaming according to another embodiment of the present disclosure;

FIG. 4 is a schematic diagram of a switching method for audio input and output applied to live streaming according to another embodiment of the present disclosure;

FIG. 5 is a schematic diagram of a live streaming device according to an embodiment of the present disclosure;

FIG. 6 is a schematic diagram of a live streaming device according to another embodiment of the present disclosure;

FIG. 7 is a schematic diagram of a switching device for audio input and output applied to live streaming according to an embodiment of the present disclosure;

FIG. 8 is a schematic diagram of a switching device for audio input and output applied to live streaming according to another embodiment of the present disclosure;

FIG. 9 is a schematic diagram of the hardware structure of a electronic device provided according to the embodiments of the present disclosure.

### DETAILED DESCRIPTION OF EMBODIMENTS

In order to make the objective, technical solution and advantages of the embodiments of the present disclosure clearer, the technical solution of the embodiments of the present disclosure will be clearly and completely described below in conjunction with the accompanying drawings. Obviously, the embodiments to be described are a part instead of all of the embodiments of the present disclosure. Based on the embodiments in the present disclosure, all other embodiments obtained by those of ordinary skill in the art without the exercise of any creative skill fall within the protection scope of the present disclosure.

With the development of Internet technology, live streaming is known and favored by more and more people.

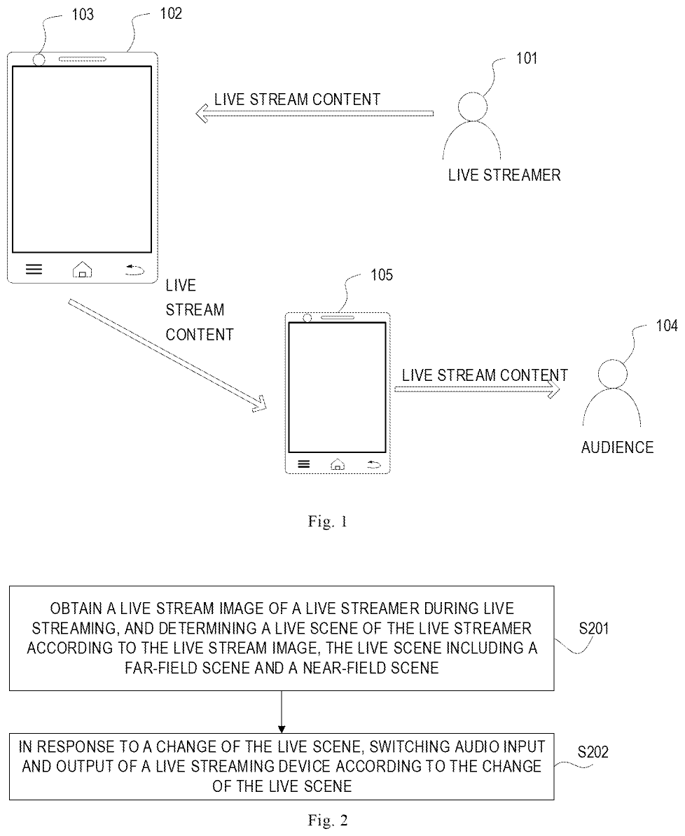

FIG. 1 is a schematic diagram of a live scene. As depicted, a live streamer 101 may complete live streaming based on a live streaming device 102, which may be a mobile phone as shown in FIG. 1 or other electronic devices. This embodiment is not intended to limit.

The live streaming device 102 can be provided with a camera 103, which may collect the live stream content of the live streamer 101 and transmit the collected live stream content to a user device 105 of an audience 104, so that the audience 104 may learn about the live stream content through the user device 105.

Likewise, the user device 105 may be a mobile phone as shown in FIG. 1 or other electronic devices. This embodiment is not intended to limit.

It is noteworthy that the foregoing example is only illustrative illustration of application scenarios to which the live streaming in this embodiment might be applicable, and should not be understood as a limitation of the scenario.

According to the distance between the live streamer and the live streaming device during live streaming, two scenarios can be divided, one of which is the far-field scene and the other of which is the near-field scene.

The far-field scene refers to the scene of live streaming in which the distance between the live streamer and the live streaming device is relatively far, while the near-field scene refers to the scene of live streaming in which the distance between the live streamer and the live streaming device is relatively close.

For example, when the live streamer dances, the live stream for distant scenes is more suitable, so that the audience watching the live stream may see the complete dancing postures of the live streamer and the audience's viewing experience may be satisfied. When the live streamer completes dancing and enters the interaction with the audience, the live streaming for near scenes is more suitable, so as to bridge the distance between the live streamer and the audience, strengthen the interaction effect and meet the audience's interactive experience.

In related arts, in order to improve the reliability of live streaming and meet the audience's experience, the live streamer needs to manually switch the audio input and output of the live streaming device when the live scene is switched.

For example, with reference to the above example description of dancing, if the live scene switches from the near-field scene (that is, the scene in which the live streamer interacts with the audience) to the far-field scene (that is, the scene in which the live streamer dances), the audio output of the live streaming device needs to be set as the external output of the live streaming device, specifically the speaker output of the live streaming device, so that the live streamer may hear the music corresponding to the dance. Then, the live streamer manually sets the audio output of the live streaming device and selects the external output of the live streaming device.

When the live streamer finishes dancing and switches from the far-field scene to the near-field scene, the audio output of the live streaming device needs to be set as the earphone output, so as to avoid the audience hearing the interactive audio information recorded by the live streaming device. Then, the live streaming device manually sets the audio output of the live streaming device and selects the earphone output connected to the live streaming device.

It should be understood that the above example only takes the dancing of the live streamer as an example (that is, the live stream content is dancing) to describe the switching of the audio input and output in related arts, but should not be understood as the limitation of the live stream content.

In order to solve at least one of the problems in the above related arts, the inventors of the present invention have obtained the invention concept of the present disclosure through creative labor: a live scene is determined according to a live stream image of a live streamer during the live streaming, so that the audio input and output of a live streaming device may be automatically switched based on the change of the live scene.

Please refer to FIG. 2, which is a schematic diagram of a switching method for audio input and output applied to live streaming according to one embodiment of the present disclosure.

As shown in FIG. 2, the method comprises:
S201: Obtain a live stream image of a live streamer during live streaming, and determine a live scene of the live streamer according to the live stream image, including a far-field scene and a near-field scene.

As an example, the execution body of this embodiment may be a live streaming device, and the live streaming device may be a device used to achieve live streams. This embodiment is not intended to limit the type, style and shape of the live streaming device.

Herein, the live stream image refers to an image of the live streamer obtained during the live streaming.

As for the implementation of obtaining the live stream image, the following approach may be adopted:

The live streaming device may be provided with an image collecting device. For example, when the method of this embodiment is applied to the application scenario shown in FIG. 1, the image collecting device may be the camera shown in FIG. 1, and the image collecting device (the camera shown in FIG. 1) may be used to obtain the image of the live streamer during the live streaming, to obtain the live stream image of the live streamer.
S202: In response to a change of the live scene, switch the audio input and output of a live streaming device according to the change of the live scene.

This step may be understood as follows: the live streaming device may determine whether the live scene has changed based on the determined live scene. If the live scene has changed, the audio input and output of the live streaming device may be switched based on the change of the live scene.

For example, when the live streaming device determines the change of the live scene, it may generate switching instructions based on the change of the live scene, and switch the audio input and output of the live streaming device based on the switching instructions.

Specifically, the live streaming device may determine the live scene based on a preset time interval, and detect whether the current live scene and the previous live scene are the same live scene. If they are different live scenes, it indicates that the live scene has changed. For example, if the current live scene is a far-field scene, and the previous live scene is a near-field scene, the live streaming device may generate switching instructions to realize the automatic switch of the audio input and output of the live streaming device.

Conversely, if the live streaming device detects that the current live scene and the previous live scene are the same live scene, there is no need to switch the audio input and output of the live streaming device.

Herein the preset time interval may be determined by the live streaming device based on needs, historical records, experiments, etc. This embodiment is not intended to limit.

In other embodiments, the live streaming device may determine the live scene in real time, e.g., detecting each frame of the live stream image collected by the image collecting device and comparing the live scene of the current frame of the live stream image with the live scene of the previous frame of the live stream image. If the live scenes of the two frames of the live stream image are different live scene, the live streaming device may generate switching instructions to realize the automatic switching of the audio input and output of the live streaming device.

Conversely, if the live streaming device detects that the current-frame live scene and the previous-frame live scene are the same live scene, there is no need to switch the audio input and output of the live streaming device.

Based on the above analysis, it may be seen that the embodiments of the present disclosure provide a switching method for audio input and output applied to live streaming, comprising: obtaining a live stream image of a live streamer during the live streaming, and determining a live scene of the live streamer according to the live stream image, the live scene comprising a far-field scene and a near-field scene; and in response to a change of the live scene, switching the audio input and output of a live streaming device according to the change of the live scene. In this embodiment, such technical features are introduced: determining the live scene based on the live stream image, and switching the audio input and output based on the change of the live scene. This avoids the drawbacks of complicated operation caused by the live streamer manually switching the audio input and output of the live streaming device when the live scene changes, improves the automation of the live streaming, satisfies the live streaming experience of the live streamer, makes the live streaming smoother as a whole, improves the reliability of the live streaming and also satisfies the viewing experience of the audience.

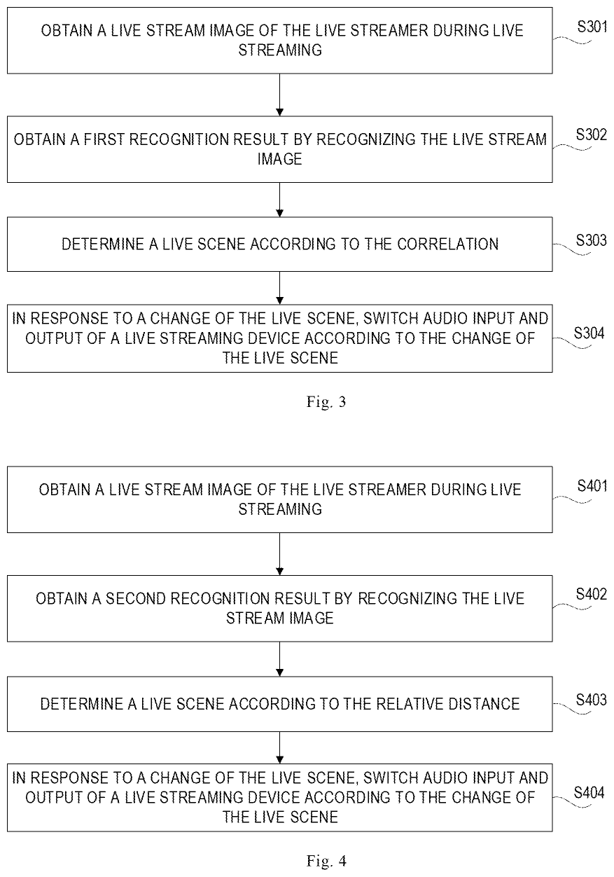

Please refer to FIG. 3, which is a schematic diagram of a switching method for audio input and output applied to a live streaming according to another embodiment of the present disclosure.

As shown in FIG. 3, the method comprises:
S301: Obtain a live image of a live streamer during the live streaming.

For example, the implementation principle of S301 may refer to the above embodiment, which will not be detailed here.
S302: Recognize the live stream image to obtain a first recognition result.

Herein, the first recognition result is used to characterize the correlation between a first human feature of the live streamer in the live stream image and a second human feature of the live streamer in the real scene.

In some embodiments, the first recognition result, i.e., the human feature of the live streamer in the live stream image (i.e., the first human feature) may be obtained by constructing a recognition model for recognizing human features and recognizing the live stream image based on the recognition model.

In one example, the first human feature may be a first human area, for example, the recognition model may recognize the body area of the live streamer in the live stream image. A second human area of the live streamer in the real scene is stored in the live streaming device, and the first recognition result characterizes the correlation between the first body area and the second body area.

In another example, the first human feature may be a first body part of the live streamer in the live stream image. For example, the recognition model determines, by recognizing the live streamer image, that the live stream image includes the head of the live streamer. The first recognition result characterizes the correlation between the first body part and the whole body part of the live streamer in the real scene.
S303: Determine the live scene according to the correlation.

In conjunction with the above example, in one example, the correlation may be a ratio of the first body area to the second body area, that is, the proportion of the body area of the live streamer in the live stream image relative to the body area of the live streamer in the real scene.

For example, if the ratio is greater than a preset first threshold, then the live scene is a far-field scene. Conversely, if the ratio is less than the first threshold, the live scene is a near-field scene.

Herein the first threshold may be set by the live streaming device based on needs, historical records, and experiments, etc. This embodiment is not intended to limit.

Generally speaking, if the ratio is relatively small, that is, the first body area is relatively small, and the live streamer is relatively close to the live streaming device, the live scene is determined to be a near-field scene.

On the contrary, if the ratio is relatively large, that is, the first body area is relatively large, and the live streamer and the live streaming device are relatively far away, then the live scene is determined to be a far-field scene.

It is noteworthy that in this embodiment, by combining the ratio of the first human feature of the live streamer in the live stream image and the second human feature of the live streaming in the real scene to determine the live scene, the determined live scene may have technical effects with high reliability and accuracy.

In another example, the correlation may be the correlation between the first body part and the whole body part. For example, the correlation may specifically be the recognition result including the head in the whole body part.

In general, if the first body part includes relatively more parts in the whole body, the live scene may be determined as a far-field scene. Conversely, if the first body part includes relatively few parts in the whole body, the live scene may be determined as a near-field scene.

For example, if it is determined, by the recognition model recognizing the live stream image, that the live stream image includes the head in the whole body of the live streamer, then the live scene is determined to be a near-field scene.

It is noteworthy that in this embodiment, the correlation between the first human feature of the live streamer in the live stream image and the second human feature of the live streamer in the real scene is determined through the first recognition result of the live stream image, so that the live scene is determined based on the correlation. Thus, the determined correlation has higher reliability and accuracy, and further, when the live scene is determined based on the correlation, the effectiveness and accuracy of the determined live scene may be improved.
S304: In response to a change of the live scene, switch the audio input and output of the live streaming device according to the change of the live scene.

As an example, for the description of S304, reference may be made to the above embodiments, which will not be repeated here.

In some embodiments, S304 may include the following embodiments:

Embodiment 1: If the change of the live scene is from a near-field scene to a far-field scene, the audio input of the live streaming device is switched to the microphone input of the live streaming device.

For example, if the live scene is a near-field scene and the audio output of the live streaming device is the headphone output, then the audio output of the live streaming device may be switched to the external output of the live streaming device when the live streaming device determines that the live scene changes from the near-field scene to the far-field scene.

Based on the above live stream for dancing, it can be seen that in the case of changes in the live scene in this embodiment, the audio output of the live streaming device is automatically switched from the headphone output to the external output of the live streaming device. In this way, the live streamer may clearly hear the dance music based on the external output of the live streaming device, thus providing more favorable conditions for the live streamer to dance, avoiding the tedious operation caused by the manual switching of live streamers, saving time and improving the effectiveness and reliability of live streaming.

Embodiment 2: If the change of the live scene is changing from the near field scene to the far field scene, the audio output of the live streaming device is switched to the external output of the live streaming device.

For another example, if the live scene is a near-field scene and the audio input of the live streaming device is the microphone input of the headset, then when the live streaming device determines that the live scene changes from a near-field scene to a far-field scene, the audio input of the live streaming device may be switched to the microphone input of the live streaming device.

According to the above live stream for dancing, in the case of changes in the live scene in this embodiment, the audio input of the live streaming device may be automatically switched from the microphone input of the headset to the microphone input of the live streaming device through the live streaming device, so that the voice of the live streamer may be heard by the audience through the microphone of the live streaming device, avoiding the tedious operation caused by the manual switching of the live streamer, saving time and improving the effectiveness and reliability of the live streaming.

It is noteworthy that embodiments 1 and 2 may be two separate embodiments, or they may be combined into a single embodiment, which is not limited in the present embodiment.

Embodiment 3: If the change of the live scene changes from the far field scene to the near field scene, the audio output of the live streaming device is switched to the headphone output.

For example, if the live scene is a far-field scene, and the audio output of the live streaming device is the external output of the live streaming device, then when the live streaming device determines that the live scene changes from a far-field scene to a near-field scene, the audio output of the live streaming device may be switched from the external output of the live streaming device to the headphone output connected to the live streaming device.

In conjunction with the above live stream for dancing, it can be seen that in the case of changes in the live scene in this embodiment, the audio output of the live streaming device may be automatically switched from the headphone output to the headphone output through the live streaming device, which can facilitate the interaction between the live streamer and the audience, meet the audience's interactive experience and improve the effectiveness and reliability of the live streaming.

Embodiment 4: If the change of the live scene is from a far-field scene to a near-field scene, the audio input of the live streaming device is switched to the microphone input of the headset connected to the live streaming device.

For example, if the live scene is a far-field scene and the audio input of the live streaming device is the microphone input of the live streaming device, then when the live streaming device determines that the live scene changes from a far-field scene to a near-field scene, the audio input of the live streaming device may be switched from the microphone input of the live streaming device to the microphone input of the headset connected to the live streaming device.

Similarly, with the solution of this embodiment, the audio information of the live streamer may be relatively completely and clearly recorded by the microphone of the headset connected to the live streaming device, so as to meet the interactive experience of the audience and improve the reliability and accuracy of the live streaming.

Please refer to FIG. 4, which is a schematic diagram of a switching method for audio input and output applied to live streaming according to another embodiment of the present disclosure.

As shown in FIG. 4, the method comprises:
S401: Obtain a live stream image of a live streamer during live streaming.

As an example, the implementation principle of S401 may be referred to the above embodiment, which will not be detailed here.
S402: Recognize the live stream image to obtain a second recognition result.

As an example, the second recognition result is used to characterize the relative distance between the live streamer and the live streaming device.

In some embodiments, a sample image may be collected, including an image of the live streamer during live streaming. A predictive model for predicting the relative distance between the live streamer and the live streaming device may be obtained by training a preset neural network model according to a according to a marked distance between the live streamer and the live streaming device (i.e., a predetermined real distance between the live streamer and the live streaming device) and the sample image.

Accordingly, in this embodiment, when the live streaming device obtains the live stream image, it may input the live stream image into the predictive model to obtain a second recognition result characterizing the relative distance.
S403: Determine the live scene based on the relative distance.

It is noteworthy that in this embodiment, by determining the relative distance between the live streamer and the live streaming device based on the live stream image and determining the live scene based on the relative distance, the reliability and accuracy of the determined live scene may be improved. Furthermore, when switching the audio input and output of the live streaming device based on the live scene, the accuracy and reliability of the switch may be achieved while performing automatic switching.

Herein, if the relative distance is less than a preset second threshold, the live scene is a near-field scene, and if the relative distance is greater than the second threshold, the live scene is a far-field scene.

Similarly, the second threshold may be set by the live streaming device based on demands, historical records and experiments, etc. This embodiment is not intended to limit.
S404: In response to a change of the live scene, switch the audio input and output of the live streaming device according to the change of the live scene.

As an example, the implementation principle of S404 may be referred to the above embodiment, which will not be detailed here.

According to another aspect of the present disclosure, an embodiment of the present disclosure provides a live streaming device.

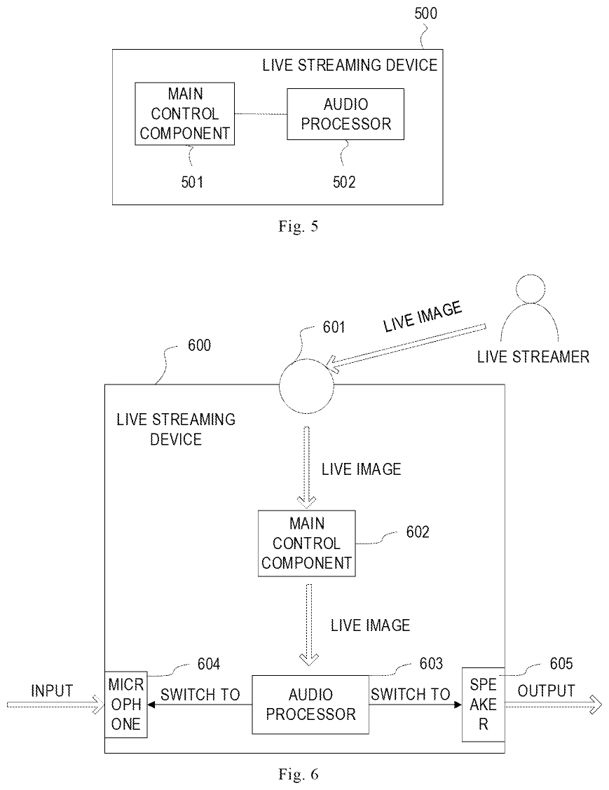

Please refer to FIG. 5, which shows a schematic diagram of a live streaming device according to an embodiment of the present disclosure.

As depicted, a live streaming device 500 comprises:

A main control component 501 is used to obtain a live stream image of a live streamer during live streaming, and determine a live scene of the live streamer according to the live stream image, including a far field scene and a near field scene.

The main control component 501 is further used to generate switching instructions in response to a change of the live scene and transmit the switching instructions to an audio processor, wherein the switching instructions are used to instruct the audio input and output of the live streaming device to be switched.

The audio processor 502 is used to switch the audio input and output of the live streaming device according to the switching instructions.

With reference to FIG. 6, this figure shows a schematic diagram of a live streaming device according to another embodiment of the present disclosure.

As depicted, a live streaming device 600 comprises:

An image collecting device 601 is used to collect a live stream image of a live streamer during live streaming and transmit the collected live stream image to a main control component 602.

Herein, the image collecting device 601 is a device with image collecting functionality, such as a camera.

The main control component 602 is used to obtain the live stream image of the live streamer during live streaming and determine a live scene of the live streamer according to the live stream image, including a far field scene and a near field scene.

For the principle of determining the live scene of the main control component 602, please refer to the description in the above embodiments, which will not be repeated here.

The main control component 602 is further used to, in response to a change of the live scene, generate switching instructions according to the change of the live scene and transmit the switching instructions to an audio processor 603, wherein the switching instructions are used to instruct the audio input and output of the live streaming device 600 to be switched.

In one example, if the main control component 602 determines that the change of the live scene is from a near field scene to a far field scene, the main control component 602 may generate switching instructions to instruct: the audio input of the live streaming device 600 to be switched to the input of a microphone 604 of the live streaming device 600; and/or,

The main control component 602 may generate switching instructions indicating that the audio output of the live streaming device 600 is to be switched to the external output of the live streaming device 600. Wherein the external output of the live streaming device 600 may be, specifically, the output of a speaker 605 as shown in FIG. 6.

In another example, if the main control component 602 determines that the change of the live scene is from the far field scene to the near field scene, the main control component 602 may generate switching instructions indicating that the audio input of the live streaming device 500 is to be switched to the microphone input of the headphone connected to the live streaming device 600; and/or,

The main control component 602 may generate switching instructions indicating that the audio output of the live streaming device 600 is to be switched to the output of the headphone connected to the live streaming device 600.

Herein, the headphone connected to the live streaming device 600 is a headphone worn by the live streamer.

An audio processor 603 is used to switch the audio input and output of the live streaming device 600 according to the switching instructions.

According to another aspect of the present disclosure, an embodiment of the present disclosure further provides an apparatus for switching audio input and output applied to live streaming.

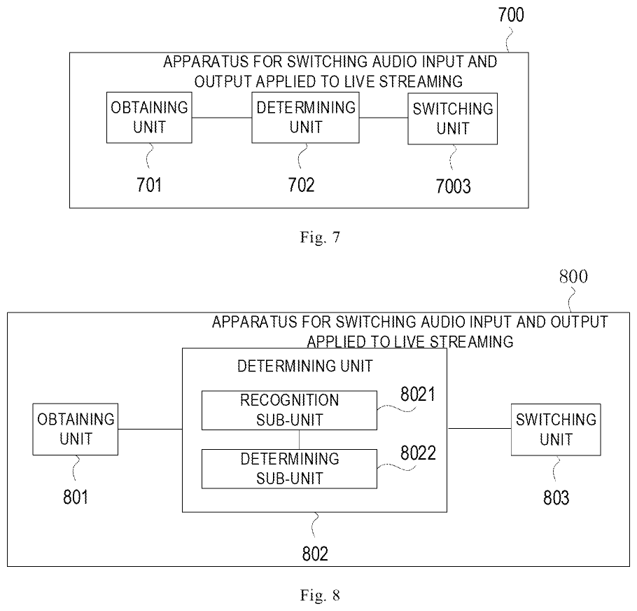

Refer to FIG. 7, which shows a schematic diagram of an apparatus for switching audio input and output applied to live streaming according to an embodiment of the present disclosure.

As depicted, an apparatus 700 for switching audio input and output applied to live streaming comprises:

An obtaining unit 701, used to obtain a live stream image of a live streamer during live streaming.

A determining unit 702, used to determine a live scene of the live streamer according to the live stream image, the live scene comprising a far-field scene and a near-field scene.

A switching unit 703, used to switch, in response to a change of the live scene, audio input and output of a live streaming device according to the change of the live scene.

Refer to FIG. 8, which shows a schematic diagram of an apparatus for switching audio input and output applied to live streaming according to another embodiment of the present disclosure.

As depicted, an apparatus 800 for switching audio input and output applied to live streaming comprises:

An obtaining unit 801, used to obtain a live stream image of a live streamer during live streaming.

A determining unit 802, used to determine a live scene of the live streamer according to the live stream image, the live scene comprising a far-field scene and a near-field scene.

In conjunction with FIG. 8, it can be seen that in some embodiments, the determining unit 802 comprises:

A recognition sub-unit 8021, used to obtain a first recognition result by recognizing the live stream image, wherein the first recognition result is used to characterize a correlation between a first human feature of the live streamer in the live stream image and a second human feature of the live streamer in a real scene;

A determining sub-unit 8022, used to determine the live scene according to the correlation.

In some embodiments, the recognition sub-unit 8021 is used to obtain a second recognition result by recognizing the live stream image, wherein the second recognition result is used to characterize a relative distance between the live streamer and the live streaming device;

The determining sub-unit 8022 is used to determine the live scene according to the relative distance.

A switching unit, used to switch, in response to a change of the live scene, audio input and output of a live streaming device according to the change of the live scene.

According to the embodiments of the present disclosure, an electronic device and a readable storage medium are further provided.

According to the embodiments of the present disclosure, a computer program product is further provided, comprising: a computer program stored in a readable storage medium, wherein at least one processor of an electronic device may read the computer program from the readable storage medium, and the at least one processor executes the computer program to cause the electronic device to execute the solution provided by any of the embodiments.

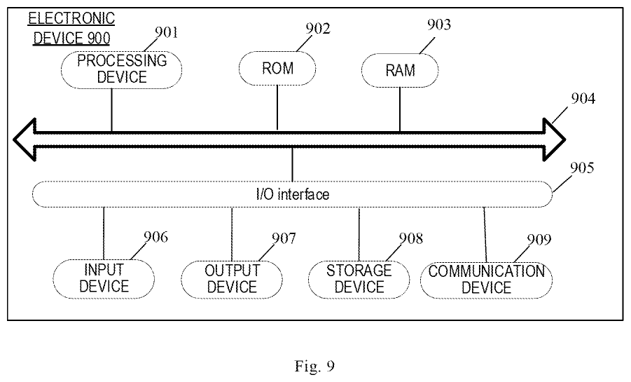

Reference is made to FIG. 9, which shows a structural schematic diagram of an electronic device 900 suitable for implementing the embodiments of the present disclosure. The electronic device 900 may be a terminal device or server. The terminal device may include, without limitation to, a mobile terminal such as a mobile phone, a laptop computer, a digital broadcast receiver, a PDA (personal digital assistant), a PAD (tablet computer), a PMP (portable multimedia player), an on-board terminal (e.g., on-board navigation terminal) and the like, as well as a fixed terminal such as a digital TV, a desktop computer and the like. The electronic device shown in FIG. 9 is merely an example and should not be construed to impose any limitations on the functionality and use scope of the embodiments of the present disclosure.

As shown in FIG. 9, the electronic device 900 may comprises processing device (e.g., a central processor, a graphics processor) 901 which is capable of performing various appropriate actions and processes in accordance with programs stored in a read only memory (ROM) 902 or programs loaded from storage device 908 to a random access memory (RAM) 903. In the RAM 903, there are also stored various programs and data required by the electronic device 900 when operating. The processing device 901, the ROM 902 and the RAM 903 are connected to one another via a bus 904. An input/output (I/O) interface 905 is also connected to the bus 904.

Usually, the following device may be connected to the I/O interface 905: input device 606 including a touch screen, a touch pad, a keyboard, a mouse, a camera, a microphone, an accelerometers, a gyroscope, or the like; output device 907, such as a liquid-crystal display (LCD), a loudspeaker, a vibrator, or the like; storage device 908, such as a magnetic tape, a hard disk or the like; and communication device 909. The communication device 909 allows the electronic device 900 to perform wireless or wired communication with other device so as to exchange data with other device. While FIG. 9 shows the electronic device 900 with various device, it should be understood that it is not required to implement or have all of the illustrated device. Alternatively, more or less device may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication device 909, or installed from the storage device 908, or installed from the ROM 902. The computer program, when executed by the processing device 901, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium including or storing a program that may be used by or in conjunction with an instruction executing system, apparatus or device. In the present disclosure, the computer readable signal medium may include data signals propagated in the baseband or as part of the carrier waveform, in which computer readable program code is carried. Such propagated data signals may take a variety of forms, including without limitation to electromagnetic signals, optical signals, or any suitable combination of the foregoing. The computer readable signal medium may also be any computer readable medium other than a computer readable storage medium that may send, propagate, or transmit a program for use by, or in conjunction with, an instruction executing system, apparatus, or device. The program code contained on the computer readable medium may be transmitted by any suitable medium, including, but not limited to, a wire, a fiber optic cable, RF (radio frequency), etc., or any suitable combination thereof.

The above computer readable medium may be contained in the above electronic device; or it may exist separately and not be assembled into the electronic device.

The above computer readable medium carries one or more programs which, when executed by the electronic device, cause the electronic device to perform the method described in the above embodiments.

Computer program code for carrying out operations of the present disclosure may be written in one or more program designing languages or a combination thereof, which include without limitation to an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. Units involved in the embodiments of the present disclosure as described may be implemented in software or hardware. The name of a unit does not form any limitation on the module itself.

The functionality described above may at least partly be performed, at least in part, by one or more hardware logic components. For example and in a non-limiting sense, exemplary types of hardware logic components that can be used include: field-programmable gate arrays (FPGA), application specific integrated circuits (ASICs), application specific standard products (ASSPs), systems on chips (SOCs), complex programmable logic devices (CPLDs), etc.

In the context of the present disclosure, the machine readable medium may be a tangible medium that can retain and store programs for use by or in conjunction with an instruction execution system, apparatus or device. The machine readable medium of the present disclosure can be a machine readable signal medium or a machine readable storage medium. The machine readable medium may include, but is not limited to, an electronic, magnetic, optical, electromagnetic, infrared or semiconductor system, apparatus or device, or any combination of the foregoing. More specific examples of the machine readable storage medium may include, without limitation to, the following: an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In a first aspect, according to one or more embodiments of the present disclosure, provided is a switching method for audio input and output applied to live streaming, comprising:
obtaining a live stream image of a live streamer during live streaming, and determining a live scene of the live streamer according to the live stream image, the live scene including a far-field scene and a near-field scene.
in response to a change of the live scene, switching audio input and output of a live streaming device according to the change of the live scene.

According to one or more embodiments of the present disclosure, the determining a live scene of the live streamer according to the live stream image comprises:
obtaining a first recognition result by recognizing the live stream image, wherein the first recognition result is used to characterize a correlation between a first human feature of the live streamer in the live stream image and a second human feature of the live streamer in a real scene;
determining the live scene according to the correlation.

According to one or more embodiments of the present disclosure, the correlation characterizes a ratio of the first human feature to the second human feature.

According to one or more embodiments of the present disclosure, if the ratio is greater than a preset first threshold, the live scene is a far-field scene; If the radio is less than the first threshold, the live scene is a near-field scene.

According to one or more embodiments of the present disclosure, if the change of the live scene is changing from the near-field scene to the far-field scene, the switching audio input and output of a live streaming device according to the change of the live scene comprises:
switching the audio input of the live streaming device to a microphone input of the live streaming device, switching the audio output of the live streaming device to an external output of the live streaming device.

According to one or more embodiments of the present disclosure, if the change of the live scene is changing from the far-field scene to the near-field scene, the switching audio input and output of a live streaming device according to the change of the live scene comprises:
switching the audio input of the live streaming device to a microphone input of a headphone connected to the live streaming device, switching the audio output of the live streaming device to an output of the headphone.

According to one or more embodiments of the present disclosure, the determining a live scene of the live streamer according to the live stream image comprises:
obtaining a second recognition result by recognizing the live stream image, wherein the second recognition result is used to characterize a relative distance between the live streamer and the live streaming device;
determining the live scene according to the relative distance.

According to one or more embodiments, if the relative distance is less than a preset second threshold, the live scene is a near-field scene;

If the relative distance is greater than the second threshold, the live scene is a far-field scene.

In a second aspect, according to one or more embodiments of the present disclosure, provided is an apparatus for switching audio input and output applied to live streaming, comprising:
a main control component, used to obtain a live stream image of a live streamer during live streaming, and determining a live scene of the live streamer according to the live stream image, the live scene including a far-field scene and a near-field scene;
wherein the main control component is further used to generate switching instructions in response to a change of the live scene and transmit the switching instructions to an audio processor, wherein the switching instructions are used to instruct the audio input and output of the live streaming device to be switched;
the audio processor is used to switch the audio input and output of the live streaming device according to the switching instructions.

According to one or more embodiments of the present disclosure, there is further comprised:
an image collecting device, used to collect a live stream image of the live streamer during live streaming and transmit the collected live stream image to the main control component.

According to one or more embodiments of the present disclosure, the main control component is used to: obtain a first recognition result by recognizing the live stream image, wherein the first recognition result is used to characterize a correlation between a first human feature of the live streamer in the live stream image and a second human feature of the live streamer in a real scene; and determine the live scene according to the correlation.

According to one or more embodiments of the present disclosure, the correlation characterizes a ratio of the first human feature to the second human feature.

According to one or more embodiments of the present disclosure, if the ratio is greater than a preset first threshold, the live scene is a far-field scene; If the radio is less than the first threshold, the live scene is a near-field scene.

According to one or more embodiments of the present disclosure, if the change of the live scene is changing from the near-field scene to the far-field scene, the switching instructions are used to indicate that the audio input of the live streaming device is to be switched to a microphone input of the live streaming device, and the audio output of the live streaming device is to be switched to an external output of the live streaming device.

According to one or more embodiments of the present disclosure, if the change of the live scene is changing from the far-field scene to the near-field scene, the switching instructions are used to indicate that the audio input of the live streaming device is to be switched to a microphone input of a headphone connected to the live streaming device, and the audio output of the live streaming device is to be switched to an output of the headphone.

According to one or more embodiments of the present disclosure, the main control component is used to: obtain a second recognition result by recognizing the live stream image, wherein the second recognition result is used to characterize a relative distance between the live streamer and the live streaming device; determine the live scene according to the relative distance.

According to one or more embodiments, if the relative distance is less than a preset second threshold, the live scene is a near-field scene;

If the relative distance is greater than the second threshold, the live scene is a far-field scene.

In a third aspect, according to one or more embodiments of the present disclosure, an electronic device is provided, comprising: at least one processor and a memory;
the memory storing computer executable instructions;
the at least one processor executing computer executable instructions stored in the memory to cause the at least one processor to perform the method according to the first aspect and various possible methods according to the first aspect.

In a fourth aspect, according to one or more embodiments of the present disclosure, provided is a computer readable storage medium, in which computer executable instructions are stored, the computer executable instructions, when executed by a processor, implementing the method according to the first aspect and various possible methods according to the first aspect.

In a fifth aspect, according to one or more embodiments of the present disclosure, provided is a computer program product which, when executed by a processor, implementing the method according to the first aspect and various possible methods according to the first aspect.

In a sixth aspect, according to one or more embodiments of the present disclosure, an apparatus for switching audio input and output applied to live streaming is provided, comprising:
an obtaining unit, used to obtain a live stream image of a live streamer during live streaming;
a determining unit, used to determine a live scene of the live streamer according to the live stream image, the live scene comprising a far-field scene and a near-field scene;
a switching unit, used to switch, in response to a change of the live scene, audio input and output of a live streaming device according to the change of the live scene.

According to one or more embodiments, the determining unit comprises:
a recognition sub-unit, used to obtain a first recognition result by recognizing the live stream image, wherein the first recognition result is used to characterize a correlation between a first human feature of the live streamer in the live stream image and a second human feature of the live streamer in a real scene;
a determining sub-unit, used to determine the live scene according to the correlation.

According to one or more embodiments of the present disclosure, the correlation characterizes a ratio of the first human feature to the second human feature.

According to one or more embodiments of the present disclosure, if the ratio is greater than a preset first threshold, the live scene is a far-field scene;

If the radio is less than the first threshold, the live scene is a near-field scene.

According to one or more embodiments of the present disclosure, if the change of the live scene is changing from the near-field scene to the far-field scene, the switching instructions are used to indicate that the audio input of the live streaming device is to be switched to a microphone input of the live streaming device, and the audio output of the live streaming device is to be switched to an external output of the live streaming device.

According to one or more embodiments of the present disclosure, if the change of the live scene is changing from the far-field scene to the near-field scene, the switching instructions are used to indicate that the audio input of the live streaming device is to be switched to a microphone input of a headphone connected to the live streaming device, and the audio output of the live streaming device is to be switched to an output of the headphone.

According to one or more embodiments of the present disclosure, the determining unit comprises:
a recognition sub-unit, used to obtain a second recognition result by recognizing the live stream image, wherein the second recognition result is used to characterize a relative distance between the live streamer and the live streaming device;
a determining sub-unit, used to determine the live scene according to the relative distance.

According to one or more embodiments, if the relative distance is less than a preset second threshold, the live scene is a near-field scene;

If the relative distance is greater than the second threshold, the live scene is a far-field scene.

In a seventh aspect, according to one or more embodiments of the present disclosure, a computer program is provided which, when executed by a processor, implements the method according to the first aspect and various possible methods according to the first aspect.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion includes several specific implementation details, they should not be construed as limiting the scope of the present disclosure. Some features described in the context of separate embodiments may also be realized in combination in a single embodiment. On the contrary, various features described in the context of a single embodiment may also be realized in multiple embodiments, either individually or in any suitable sub-combinations.

While the present subject matter has been described using language specific to structural features and/or method logic actions, it should be understood that the subject matter defined in the appended claims is not necessarily limited to the particular features or actions described above. On the contrary, the particular features and actions described above are merely exemplary forms of realizing the claims. With respect to the apparatus in the above embodiment, the specific manner in which each module performs an operation has been described in detail in the embodiments relating to the method, and will not be detailed herein.

1. A method of switching audio input and output applied to live streaming, comprising:
obtaining a live stream image of a live streamer during live streaming, and determining a live scene of the live streamer according to the live stream image, the live scene including a far-field scene and a near-field scene;
in response to a change of the live scene, switching audio input and output of a live streaming device according to the change of the live scene.

2. The method of claim 1, wherein the determining a live scene of the live streamer according to the live stream image comprises:
obtaining a first recognition result by recognizing the live stream image, wherein the first recognition result is used to characterize a correlation between a first human feature of the live streamer in the live stream image and a second human feature of the live streamer in a real scene;
determining the live scene according to the correlation.

3. The method of claim 2, wherein the correlation characterizes a ratio of the first human feature to the second human feature.

4. The method of claim 3, wherein if the ratio is greater than a preset first threshold, the live scene is a far-field scene;
if the radio is less than the first threshold, the live scene is a near-field scene.

5. The method of claim 1, wherein if the change of the live scene is changing from the near-field scene to the far-field scene, switching audio input and output of a live streaming device according to the change of the live scene comprises:
switching the audio input of the live streaming device to a microphone input of the live streaming device, and switching the audio output of the live streaming device to an external output of the live streaming device.

6. The method of claim 1, wherein if the change of the live scene is changing from the far-field scene to the near-field scene, switching audio input and output of a live streaming device according to the change of the live scene comprises:
switching the audio input of the live streaming device to a microphone input of a headphone connected to the live streaming device, and switching the audio output of the live streaming device to an output of the headphone.

7. The method of claim 1, wherein determining a live scene of the live streamer according to the live stream image comprises:
obtaining a second recognition result by recognizing the live stream image, wherein the second recognition result is used to characterize a relative distance between the live streamer and the live streaming device;
determining the live scene according to the relative distance.

8. The method of claim 7, wherein if the relative distance is less than a preset second threshold, the live scene is a near-field scene;
if the relative distance is greater than the second threshold, the live scene is a far-field scene.

9-15. (canceled)

16. An electronic device, comprising: at least one processor and memory;
the memory storing computer executable instructions;
the at least one processor executing computer executable instructions stored in the memory to cause the at least one processor to perform a method of switching audio input and output applied to live streaming, the method comprising:
obtaining a live stream image of a live streamer during live streaming, and determining a live scene of the live streamer according to the live stream image, the live scene including a far-field scene and a near-field scene;
in response to a change of the live scene, switching audio input and output of a live streaming device according to the change of the live scene.

17. The device of claim 16, wherein the determining a live scene of the live streamer according to the live stream image comprises:
obtaining a first recognition result by recognizing the live stream image, wherein the first recognition result is used to characterize a correlation between a first human feature of the live streamer in the live stream image and a second human feature of the live streamer in a real scene;
determining the live scene according to the correlation.

18. The device of claim 17, wherein the correlation characterizes a ratio of the first human feature to the second human feature.

19. The device of claim 18, wherein if the ratio is greater than a preset first threshold, the live scene is a far-field scene;
if the radio is less than the first threshold, the live scene is a near-field scene.

20. The device of claim 16, wherein if the change of the live scene is changing from the near-field scene to the far-field scene, switching audio input and output of a live streaming device according to the change of the live scene comprises:
switching the audio input of the live streaming device to a microphone input of the live streaming device, and switching the audio output of the live streaming device to an external output of the live streaming device.

21. The device of claim 16, wherein if the change of the live scene is changing from the far-field scene to the near-field scene, switching audio input and output of a live streaming device according to the change of the live scene comprises:
switching the audio input of the live streaming device to a microphone input of a headphone connected to the live streaming device, and switching the audio output of the live streaming device to an output of the headphone.

22. The device of claim 16, wherein determining a live scene of the live streamer according to the live stream image comprises:
obtaining a second recognition result by recognizing the live stream image, wherein the second recognition result is used to characterize a relative distance between the live streamer and the live streaming device;
determining the live scene according to the relative distance.

23. The device of claim 16, wherein if the relative distance is less than a preset second threshold, the live scene is a near-field scene;
if the relative distance is greater than the second threshold, the live scene is a far-field scene.

24. A non-transitory computer readable storage medium having computer executable instructions stored thereon, the computer executable instructions, when executed by a processor, implementing a method of switching audio input and output applied to live streaming, the method comprising:
obtaining a live stream image of a live streamer during live streaming, and determining a live scene of the live streamer according to the live stream image, the live scene including a far-field scene and a near-field scene;
in response to a change of the live scene, switching audio input and output of a live streaming device according to the change of the live scene.

25. The medium of claim 24, wherein the determining a live scene of the live streamer according to the live stream image comprises:
obtaining a first recognition result by recognizing the live stream image, wherein the first recognition result is used to characterize a correlation between a first human feature of the live streamer in the live stream image and a second human feature of the live streamer in a real scene;
determining the live scene according to the correlation.

26. The medium of claim 25, wherein the correlation characterizes a ratio of the first human feature to the second human feature.

27. The medium of claim 26, wherein if the ratio is greater than a preset first threshold, the live scene is a far-field scene;
if the radio is less than the first threshold, the live scene is a near-field scene.
